(19) United States
(12) Patent Application Publication
(10) Pub. No.: US 2004/0242158 A1
(43) Pub. Date: Dec. 2, 2004

(54) Method of calculating and displaying mutual interference in the down direction in a cellular radiotelephone network with a W-CDMA type access

(76) Inventors: Imad Fattouch, Paris (FR); Jean-Marc Hubert, Bougival (FR); Francois Vincent, Clamart (FR)

Correspondence Address: PERMAN & GREEN, 425 POST ROAD, FAIRFIELD, CT, 06824, US

(21) Appl. No.: 10/815,885

(22) Filed: Mar. 31, 2004

(30) Foreign Application Priority Data
Apr. 1, 2003 (FR) 03 04005

(51) Int. Cl. H04B 1/00; H04Q 7/20

(52) U.S. Cl. 455/63.1; 455/446

(57) ABSTRACT

The process consists of selecting a sub-set of interfering cells and a sub-set of interfered cells among a set of a radio cells in a network, fixing a plurality of calculation parameters such as threshold levels for signal/interference ratios, parameters related to the power of interfering cells and the traffic channel, then determining the service area of the interfered cells and the area including inter-cell overlaps, then calculating the attenuation of the interfering cell and the attenuation of the serving interfered cell respectively, at each point or pixel in the overlap area. An estimate of the signal/interference ratio is made for each pixel starting from attenuations and parameters. The invention is used to isolate and identify interfering cells and interfered cells. The power in the interfering cells generating an excessive disturbance can thus be adjusted.

### BACKGROUND OF THE INVENTION

1. Field of the Invention

This invention relates to the domain of mobile radiotelephony communication systems. This invention relates particularly to a method of calculating and displaying interference generated by a cell or group of cells in the down direction, for the purposes of planning and optimizing a cellular radiotelephony network in which the radio interface is based on a W-CDMA type protocol (Wideband Code Distributed Multiple Access). The invention also relates to a system for implementing the process.

2. Brief Description of Related Developments

A UMTS (Universal Mobile Telecommunications System) type radio network is distinguished from a Global System with Mobile communications (GSM) particularly due to the new wideband code distributed multiple access (W-CDMA) technique. The multiple access technique adopted for the radio interface between a user equipment and Node B is one of the essential aspects of cellular networks. W-CDMA was chosen due to constraints specific to the UMTS radio interface: variable flows, variable quality of service (QoS). With this technique, the interference level increases as the number of mobiles in the cell increases. Therefore, the W-CDMA system is limited by noise. Consequently, this system requires control over power.

Unlike GSM, each transmitting station does not have its own frequency and the only way to reduce interference is for the station to adjust the power. A method of predicting interference is necessary to optimize this power control.

The so-called Monte Carlo method and derived methods have been used in prior art to simulate interference. This type of method consists of statistically putting mobiles on a map and then simulating power control. Interference in the up direction, in other words generated by mobiles themselves placed on the map, can then be calculated. However, obtaining a statistical position of mobiles is particularly difficult since several draws (Monte Carlo draws) are necessary and these calculations are particularly long. The Monte Carlo method can also be used in the down direction, in other words from stations to mobiles.

This method can be adopted for very precise positioning but it may be difficult to use it for a very large network. Moreover, it is unusable for identifying and isolating the cells with greatest interference, within a group of cells.

Consequently, there is a need for a simple, fast, less theoretical and more operational method of isolating and identifying interfering and interfered cells.

### SUMMARY OF THE INVENTION

One purpose of this invention is to eliminate one or several disadvantages of prior art by proposing a method of better identifying operating problems due to interference in the down direction.

The UMTS network enables high speed transmission of large volume files to mobiles in response to requests presented in the form of small packets sent in the up direction. The result is that the load in the down direction is always greater than the load in the up direction. Therefore, interference depends more particularly on the power supplied in the down direction.

Another purpose of this invention is to calculate and display interference generated by one group of interfering cells on another group of cells, taking account of the service, the traffic, the load and the power in the down direction of each cell.

For this purpose, the invention relates to a process for calculation and display of mutual interference in the down direction generated in a cellular radiotelephony network with a W-CDMA type access, used with a computer system comprising memory means for storing data representative of network coverage maps (CN) in particular, display means, selection means for selecting network cells by interactive interface means and a calculation module (11), characterized in that it comprises:

a step to select a representation of a working area derived from map data (CN) and covered by a set of cells, using interactive means on a display device,

a step to select cells in a subset of cells considered to be interfering, or a subset of cells considered as being interfered, among any of the cells in the set covering the working area represented using selection means on display means,

a step for input of threshold levels for signal/interference ratios and at least one parameter related to the power of the interfering cells, a parameter for a traffic channel to be studied and a parameter for a contour delimiting a calculation area in the working area, using the configuration means,

a step in which the calculation module determines the geographic area served by the subset of interfered cells called the service area and representing this service area,

a step in which the calculation module estimates the overlap of each of the interfering cells with the service area to define and memorize an overlap area in the memory means,

a step in which the calculation module calculates the received field level from the interfering cell, or the received field level from the interfered cell serving the pixel considered, at each point or pixel in the overlap area,

a step in which the calculation module calculates the interfering field which is the sum of the received fields from all interfering cells, at each point or pixel in the overlap area;

the calculation mode calculating the value I_{0 near} of the interference field created by each interfering cell for the calculation of a matrix and the sum of fields created by all interfering cells, starting from attenuation data and cell power defined as a parameter, for each pixel in the overlap area.

According to another feature of the invention, a step for estimating a value representing the signal/interference ratio is done for each pixel, starting from field levels and parameters.

According to another feature of the invention, parameters related to the traffic channel comprise the flow in the channel, a target signal/interference ratio, and an average power per channel.

According to another feature, the power of the interfering cells is defined by parameters for the case with maximum interference, when the interfering cells are served by a node B in the network emitting at full power.

According to another feature, the power of the interfering cells is defined by parameters for the minimum interference case, with an emission limited to the common pilot channel CPICH of base stations in the network.

According to another feature, the threshold levels for signal/interference ratios are functions of geomarketing data representative of a required quality of service, memorized in a memory of the computer system.

According to another feature, an interference matrix is formed by an integration operation over the entire overlap area of all results obtained for each pixel of the overlap area, the calculation module determining the global interference ratio Tbi/j of each serving interfered cell by interfering cells.

Therefore, the process makes it easier to select a reduced number of stations, for example those with greatest interference and the required calculation power is thus reduced. A good precision is also reached since interference matrix better takes into account ground specificity for interference forecasting.

According to another feature, the Eb/N₀ ratio of the average power of the signal to the average spectral density of the noise is calculated at each pixel in the overlap area by the calculation module using the following formula:

Eb/N₀=Ec/I₀+spread gain,

where I₀ is the total value of the interference field, and where I₀=ΣI_{0 near}+thermal noise+I_{0 serving}, Ec is the value of the average power of the signal from the serving cell for the pixel, I_{0 serving} is the value of the interference field of the serving cell and the spread gain corresponds to the throughput value of the channel chosen as a parameter, the values for Ec and I_{0 serving} previously being determined by the calculation module from attenuation data and the power fixed as a parameter for this cell.

According to another feature, the comparison means enable the calculation module to select at least three interfering cells forming the cells introducing the greatest disturbance in comparison with values of the interfering matrix.

According to another feature, a step for the display of the value of the Eb/N₀ ratio of the average power of the signal to the average spectral density of the noise is made for each pixel, for interfered cells in the overlap area using interactive interface means, the disturbance sub-areas being identified by the use of a specific graphic representation for pixels of a serving interfered cell for which the Eb/N₀ ratio is less than a threshold signal/interference ratio threshold defined as a parameter for the serving interfered cell.

According to another feature, the calculation module determines the Eb/N₀ or the Ec/I₀ ratio at each pixel in the overlap area, this ratio being compared at each pixel in the service area with a threshold indicated as a parameter so as to calculate a value representative of the excess power of the interfering cell for each interfering cell—serving interfered cell pair, this value being entered in a matrix.

According to another feature, the calculation module determines the Eb/N₀ or Ec/I₀ ratio at each pixel in the overlap area, this ratio being compared at each pixel in the service area with a threshold indicated as a parameter so as to calculate a value representative of the disturbance within the interfered cell, for each interfered cell, the value of I₀ being equal to the sum of interference generated by interfering cells.

According to another feature, the result of the calculated disturbance is used to make a check of the power for at least the most disturbing cell, by modification of the radiation diagram of an adaptive antenna of the cell, to increase the signal/interference ratio in this cell.

Another purpose of the invention is to provide a solution to one or several problems encountered in prior art by defining a computer system for use of the process according to the invention.

This aim is achieved with a computer system for calculation and display of mutual interference in the down direction generated in a cellular radiotelephony network with a W-CDMA type access for implementation of the process according to claim 1, comprising memory means, a calculation module and selection means, the said memory means comprising data representative of geographic maps (CN), broken down into a plurality of points or pixels depending on the breakdown of the said network in a first memory, and data representative of a radio coverage related to the network in a second memory, the said system being characterized in that it comprises:

interactive interface means between the user and the said system, connected to the selection means for selecting and displaying at least one working area derived from map data (CN) and covered by a set of radio coverage cells arranged according to a layout defined by the data in the second memory,

configuration means selected by interactive means to memorize a first sub-set of cells to be considered as being interfering and a second sub-set of cells to be considered as being interfered, in a configuration file for the system starting from any cells in the assembly covering the working area, the configuration means enabling firstly the definition of threshold levels for signal/interference ratios and parameters related to the power of interfering cells, the traffic channel to be studied and the contour delimiting a calculation area in the working area, and also the memorization of these data in a configuration file, the calculation module comprising means of determining the service area served by the sub-set of the interfered cells, means of estimating the overlap of each interfering cell with the service area to define and memorize an overlap area in a memory in memorization means, and means of calculating the attenuation of the interfering cell, and attenuation of the serving interfered cell for the pixel considered, for each point or pixel in the overlap area.

According to another feature, the calculation module is connected to means for extraction of data from the configuration file and data representative of attenuations stored in a third memory of the memorization means, the calculation module determining a value representative of the signal/interference ratio at each pixel in the overlap area, starting from attenuations stored in the third memory and parameters of the configuration file.

According to another feature, the interactive interface means comprise means of displaying the value representative of the signal/interference ratio Eb/N₀, the average power of the signal to the average noise spectral density, and means of representing the disturbance represented by specific pixels for which the Eb/N₀ ratio is less than a threshold ratio of the signal/interference ratio input as a parameter for the serving interfered cell for each serving interfered cell of the sub-areas, and for each pixel in the overlap area.

According to another feature, the system of the invention comprises remote control means for controlling the power in at least one interfering cell causing the greatest disturbance, by modification of the radiation diagram of an adaptive antenna of the said interfering cell.

### BRIEF DESCRIPTION OF THE DRAWINGS

The invention, with its characteristics and advantages will become clearer after reading the description made with reference to the attached drawings provided as non-limitative examples in which:

FIG. 1 diagrammatically shows a computer system according to the invention and a map of the working area of a radio network with W-CDMA access displaying mutual interference in the down direction calculated by the process according to the invention,

FIG. 2 diagrammatically shows the working area in FIG. 1 selected by the user in a UMTS type radio network,

FIG. 3 shows a matrix of disturbance coefficients between cells, acting as a database and obtained after use of the process according to the invention,

FIG. 4 shows an example of a process with several steps used in the invention to calculate interference and to create disturbance maps,

FIG. 5 shows configuration means for performing the preliminary cell selection phase and for inputting data and parameters necessary for the calculation process according to the invention, into a configuration file.

### DETAILED DESCRIPTION OF THE PREFERRED EMBODIMENT(s)

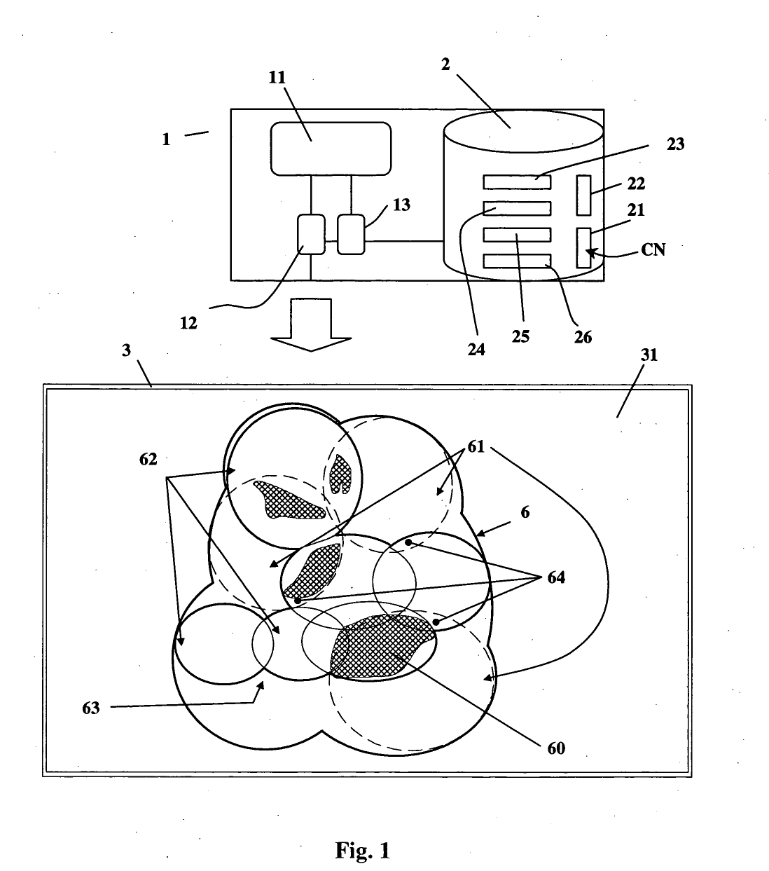

We will now describe the invention in relation to FIGS. 1, 2 and 5.

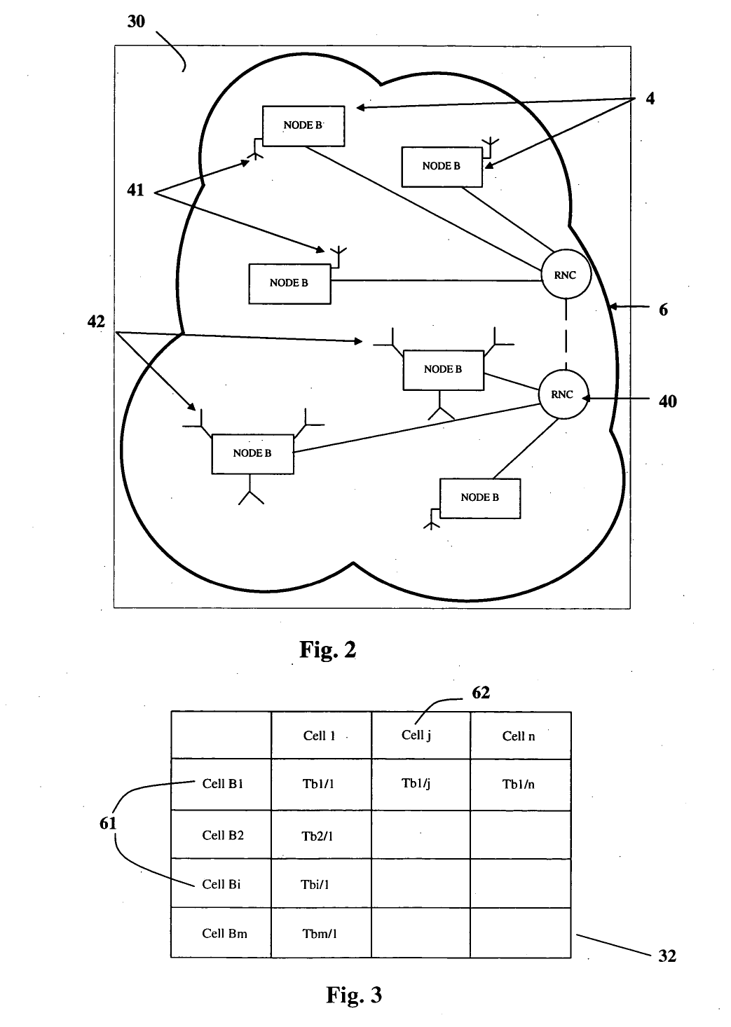

Specifically, in the down direction of a UMTS type radio network or a similar type of network operating with the W-CDMA protocol, any reception or transmission device formed by a Node B (4, FIG. 2) transmits a signal through an antenna (41, 42) on a frequency band common to all mobile terminals of users of this network. FIG. 2 shows an example of a portion (30) of the UMTS type radio access network that the user of the computer system (1) according to the invention can select on the computer system display to study mutual interference between cells. As shown in FIG. 2, a Node B (4) may for example be associated with an omni-directional antenna (41) or at least one sectorial antenna (42) transmitting in a single sector. Communications are routed between the Node B (4) and the core of the network using RNC (Radio Network Controller) elements (40). Each antenna (41, 42) in operation covers a territorial area that defines a radio cell within which user equipment can communicate with the network.

Memory means (2) of the computer system (1) according to the invention comprise a first memory (21) for storing data representative of geographic maps representing a territory and broken down into a plurality of points or pixels according to the network breakdown. The memory means (2) also comprise a second memory (22) for storing data representative of a radio coverage related to the network. As shown in FIG. 1, the system (1) is provided with other memories (23, 24, 25, 26) for storing data or parameters necessary to calculate interference. Among these memory means (2), one memory (24) memorizes geomarketing data that can be used to assign a variable quality of service depending on the nature (for example town, road or countryside) of the studied territorial areas. The computer system (1) also comprises interactive interface means (3) for inputting and displaying data, and selection means (12) that the user can use to choose to display a specific working area (6) covered by a set of radio cells in the network. The user starts from this working area (6) derived from map data shown on the display, and chooses a sub-set of cells (61) that he wants to consider as being interfering and a sub-set of cells (62) that can be considered as being interfered.

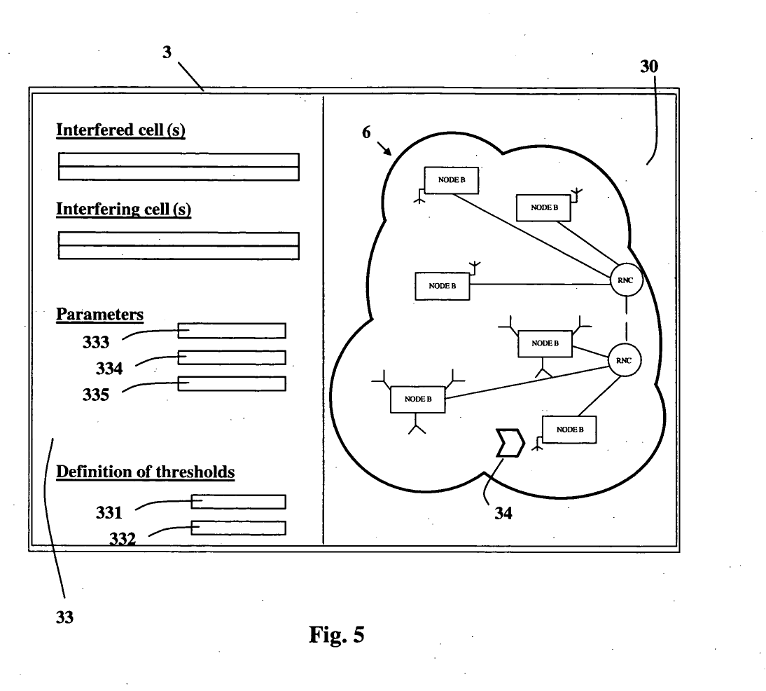

The user does this by selecting a configuration interface (33), using interactive means (3) and a menu. In the embodiment in FIG. 5, each sub-set of cells can be selected using an indicator (34) that can be moved in the working area (6). The selection method may involve selecting the antenna (41, 42) corresponding to the chosen cell.

Each of the two sub-sets may be reduced to a single Node B (4) or even to a single cell. The sub-set of interfered cells and the sub-set of interfering cells may have cells in common or they may even be identical. In one embodiment of the invention, the selection is made for example by highlighting a set of representations of cells taken by displacing the indicator (34) to bring it to the “interfered cell” or “interfering cell” box to display the corresponding list. The configuration interface (33) can also be used to input level thresholds in a display window area, for example (331) for interfering cells (61) and (332) for interfered cells (62), for signal/interference ratios and parameters related to the power of the interfering cells (333), the traffic channel (334) to be studied and the contour (335) delimiting a calculation area in the working area. Additional calculation parameters could be considered. All data input through the configuration interface (33) are stored in the memory means (2) of the computer system (1), in a configuration file (25).

Among the parameters to be defined in a configuration file (25), the user must in particular specify if the channel used in the model is a CPICH (Common Pilot CHannel) or another traffic channel used by base stations in the network, intended for voice or for downloading data at determined flow rates. As a variant, at least one user channel for which the power is defined by parameters can be considered. The communication direction to be considered in the process according to the invention is always in the down direction from a transmission Node B (4) to the terminal or downlink. The configuration interface (33) is used to define a flow rate, a target value of the signal to interference ratio Eb/N₀ and an average power, for the channel considered. Another parameter to be input is the power to be assigned to interfering cells. The extreme case in which the Node B (4) transmits at full power on all transmission channels could be considered, or the opposite case with a single CPICH channel, or an average case, could be considered. For example, the average case may be obtained from simulations or from indicators of an OMC equipment supervision center. In one embodiment of the invention, the user can also define the contour of the calculation area. The user can thus use an indicator or an equivalent selection means to eliminate fairly insignificant geographic areas, for example such as lakes, ponds and parks, from the working area (6).

The configuration interface (33) also includes different Eb/N₀ thresholds that the user would like to adapt, as a function of the channel input as a parameter. These thresholds stored in the configuration file (25) are chosen to guarantee different quality of service levels, and are stored in a configuration file (25). This type of threshold may be adapted as a function of geomarketing data corresponding to a required quality of service as a function of recommendations derived from studies, simulations and field measurements.

Once the calculation data and parameters have been input, the computer system (1) can continue with the calculation phase. The system (1) includes a calculation module (11) comprising means of determining the service area (63) served by the sub-set of interfered cells (62). In one embodiment of the invention, this service area (63) is included in the calculation area defined by the user. The calculation module (11) also comprises means of estimating the overlap of each interfering cell (61) with the service area (63) to define a global overlap area (64) and memorize it in a memory (23) of the memory means (2). This global overlap area (64) between interfering cells (61) and a service area (63) may for example include several distinct overlap areas as shown in FIG. 1. In the remaining description, the overlap area (64) denotes all areas composed of distinct overlap areas between interfering cells (61) and cells belonging to the service area (63). This overlap is calculated taking account of calculation parameters stored in the configuration file (25).

Maps derived from digital map (CN) data stored in the first memory (21) of the memory means (2) are broken down into pixels to obtain a very local distinction of interference problems. For example, one pixel may correspond to an area smaller than 0.5 km². In variant embodiments, the digital map (CN) includes in particular natural and artificial relief, and their nature (for example forests, buildings or others), to calculate an estimate of the radio attenuation of the link affected by the relief. The calculation module (11) in the system (1) includes means of calculating the attenuation of the interfering cell (61), and the attenuation of the serving interfered cell for the pixel considered, for each pixel in the overlap area (64). The attenuation is the result of the calculation made by radio propagation models. For the construction of a matrix to display interference, the interfering field level is the level of each interfering cell (61) this field level being determined particularly taking account of power—attenuation data. In the case of a global display on a selected area, the interfering field is the sum of field levels received from all interfering cells (61). Data representing attenuations thus calculated are stored in a third memory (26) of the memory means (2).

In one embodiment of the invention, the calculation module (11) related to means (13) of extracting data from the configuration file (25) and data representing calculated attenuations, is used to determine a value representative of the signal to interference ratio for each pixel in the overlap area (64), making use of attenuations stored in the third memory (26) and parameters in the configuration file (25). For example, the calculation module calculates the signal/interference ratio Eb/N₀ representing the average power of the signal divided by the average spectral density of the noise, and the ratio Ec/I₀ representing the average power of the signal transmitted by the interfering cell divided by the noise, for each pixel in the overlap area (64), using the corresponding attenuations in each pixel, the channel defined in the parameters and its throughput that represents the spread gain, the average power of the channel, and using the power of the interfering cell (61). The Eb/N₀ and Ec/I₀ ratio may be compared with a threshold indicated as a parameter, for each pixel in the service area (63), to calculate a value representative of the disturbance within each interfered cell (62). As a variant, this comparison can be made in the overlap area (64) only.

The interactive interface means (3) comprise means of displaying the value representative of the signal/interference ratio Eb/N₀, representing the average power of the signal divided by the average spectral density of the noise, for each pixel in the overlap area (64). As shown in FIG. 1, the interactive interface means (3) also include means of representing interfered cells (62) serving disturbance sub-areas (60) by specific pixels for which the Eb/N₀ ratio is less than a threshold level of the signal/interference ratio input as a parameter for the serving interfered cell (62). For example, the graphic representation of pixels in disturbance sub-areas (60) may consist of using a different type of color or shading, as shown in the interference disturbances map (31) in FIG. 1.

In one embodiment of the invention, the calculation module (11) determines the value I_{0 near} of the interference field created by each interfering cell (61), for each pixel in the overlap area (64), making use of attenuations and the power of cells fixed as a parameter. The ratio Eb/N₀ of the average signal power divided by the average noise spectral density is then calculated for each pixel in the overlap area (64) using the calculation module (11) according to the following formula:

Eb/N₀=Ec/I₀+spread gain,

where I₀ is the total value of the interference field, and where I₀=ΣIₙₑₐᵣ +thermal noise +I_{0 serving}, Ec is the value of the average power of the signal from the serving cell for the pixel, I_{0 serving} is the value of the interference field of the serving cell and the spread gain corresponds to the throughput value of the channel chosen as a parameter, the values for Ec and I_{0 serving} previously being determined by the calculation module (11) from attenuation data stored in the third memory (26) and the power fixed as a parameter for this serving cell.

We will now describe the invention with reference to FIGS. 1, 3 and 4.

In the embodiment shown in FIG. 3, an “interference” matrix (32) is formed by an integration operation over the entire overlap area (64). The statistics calculated for each interfering cell (61)/serving interfered cell (62) pair may be represented in matrix form. The calculation module (11) determines the global interference ratio Tbi/j for each serving cells (62) interfered by interfering cells (61). This ratio Tbi/j is set in the matrix table shown in FIG. 3, at the intersection of the column corresponding to the interfered cell (62) and the row corresponding to the interfering cell (61). The interference rates, also called disturbance coefficients, can be stored in memory means (2) and be used as databases.

In order to form this matrix (32), the calculation module may for example determine the Eb/N₀ or Ec/I₀ ratio for each pixel in the overlap area (64), and this ratio is then compared with a threshold indicated by the user as a parameter, for each pixel in the service area (63), so as to calculate a value representing the excess power of the interfering cell (61) for each interfering cell (61)—serving interfered cell (62) pair, for example obtained by taking the simple difference between the value reached and the threshold value of Eb/N₀ input by the user as a parameter. In one embodiment of the invention, the value representing the Tbi/j interference ratio is entered into the matrix (32). The use of this type of matrix (32) with disturbance coefficients provides an easy means of making decisions within the context of reducing interference and optimizing the UMTS network. Moreover, it is easy to organize actions by taking priority actions on the antennas (61, 62) on sites generating most interference. In one embodiment of the invention, the calculation module (11) can select at least three interfering cells (61) forming the disturbing cells introducing the greatest disturbance in comparison with values of the disturbance coefficients matrix (32).

The antennas (61, 62) used to form the radio cells of the UMTS network may for example be adaptive antennas for which the radiation diagram can be adjusted. The computer system (1) according to the invention can include remote control means (not shown) capable of modifying the radiation diagram of an adaptive antenna, to increase the signal/interference ratio in the cell generated by the antenna, in order to directly control the power of antennas (61, 62) that generate excessive interference. This type of power adjustment can be made in at least the interfering cell generating the greatest disturbance. In one embodiment of the invention, each antenna (61, 62) corresponding to one of the interfering cells (61) creating the largest disturbance could be adjusted automatically. For example, this would be possible by remote control of a knob or another motor controlled element shifting the phase of the antenna dipoles.

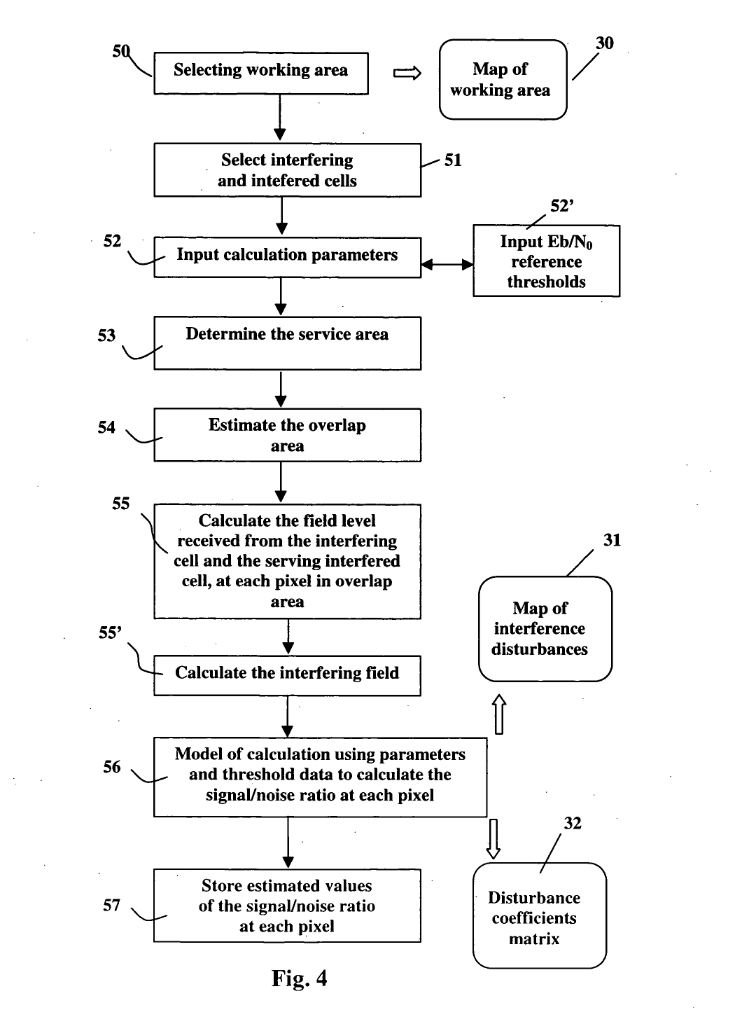

FIG. 4 summarizes the different phases in the process according to the invention. Thus, it can be understood that the preliminary step (50) to select the working area (6) provides a means of displaying a map (30) of the working area, using interactive means (3). The process continues with a step (51) to select interfering cells (61) and interfered cells (62). This step (51) can be restricted to a very limited number of interfering cells (61). The next step is to input calculation parameters (52) and input Eb/N₀ reference thresholds (52′), particularly to adapt the communication quality as a function of the importance of an area being studied for marketing purposes. This is followed by a step (53) in which the calculation module (11) determines the service area (63) and represents this service area (63). This is followed by a step (54) to estimate the overlap area (64) and a step (55) in which the calculation module (11) calculates field levels received from the selected cells. The interfering field, that is the sum of fields received from all interfering cells (61), is also calculated during an additional step (55′).

The calculation module (11) then performs a modeling step (56) to determine the signal/noise ratio at each point in the overlap area (64). The system (1) according to the invention can be used to build up an interference disturbances map (31), to display the interference directly, taking account of the above-mentioned model. Similarly, the system can be used to form a matrix of disturbance coefficients that can easily be used to optimize the UMTS radio network. Data representative of the values of the signal/noise ratio for each pixel in the overlap area (64) are stored in the memory means (2) during a storage step (57).

The advantages of the process according to the invention include the fact that it makes a minimum number of assumptions and the simplicity of the calculation compared with methods requiring samples. The invention minimizes estimating errors, while very quickly detecting interfering cells with high interference ratios. Therefore, the process makes it possible to take priority actions on “black points” in a network for which the radio interface operates according to the W-CDMA protocol.

Another advantage of the invention is that it gives a more operational aspect to the impact of bad engineering or planning. Furthermore for example, with this method, a UMTS or equivalent radio network can be optimized throughout its development period.

Persons skilled in the art will find it obvious that this invention could be used for embodiments in many other specific forms without going outside the scope of the invention as claimed. Consequently, these embodiments must be considered as being provided for illustrative purposes, but they can be modified within the limits defined by the scope of the attached claims, and the invention must not be limited to the details given above.

What is claimed is:

1. Process for calculation and display of mutual interference in the down direction generated in a cellular radiotelephony network with a W-CDMA type access, used with a computer system (1) comprising memory means (2) for storing data representative of network coverage maps (CN) in particular, display means, selection means (34) for selecting network cells by interactive interface means (3) and a calculation module (11), characterized in that it comprises:
a step (50) to select a representation of a working area (6) derived from map data (CN) and covered by a set of cells, using interactive means (3) on a display device,
a step (51) to select cells in a subset of cells (61) considered to be interfering, or a subset of cells (62) considered as being interfered, among any of the cells in the set covering the working area (6) represented using selection means (34) on display means,
a step (52, 52′) for input of threshold levels for signal/interference ratios and at least one parameter related to the power of the interfering cells (61), a parameter for a traffic channel to be studied and a parameter for a contour delimiting a calculation area in the working area (6), using the configuration means (33),
a step (53) in which the calculation module (11) determines the geographic area served by the subset of interfered cells (61) called the service area (63) and representing this service area (63),
a step (54) in which the calculation module estimates the overlap of each of the interfering cells (61) with the service area (63) to define and memorize an overlap area in the memory means (2),
a step (55) in which the calculation module (11) calculates the received field level from the interfering cell (61), or the received field level from the interfered cell (62) serving the pixel considered, at each point or pixel in the overlap area (64),
a step (55′) in which the calculation module (11) calculates the interfering field which is the sum of the received fields from all interfering cells (61), at each point or pixel in the overlap area (64);
the calculation mode calculating the value Iₙₑₐᵣ of the interference field created by each interfering cell for the calculation of a matrix and the sum of fields created by all interfering cells, starting from attenuation data and cell power defined as a parameter, for each pixel in the overlap area.

2. Process according to claim 1, in which a step (56) for estimating a value representing the signal/interference ratio is done for each pixel, starting from field levels and parameters.

3. Process according to claim 1, in which parameters related to the traffic channel comprise the flow in the channel, a target signal interference ratio, and an average power per channel.

4. Process according to claim 1, in which the power of the interfering cells (61) is defined by parameters for the case with maximum interference, when the interfering cells are served by a node B (4) in the network emitting at full power.

5. Process according to claim 1, in which the power of the interfering cells (61) is defined by parameters for the minimum interference case, with an emission limited to the common pilot channel CPICH of base stations in the network.

6. Process according to claim 1, in which the threshold levels for signal/interference ratios are functions of geomarketing data representative of a required quality of service, memorized in a memory (24) of the computer system.

7. Process according to claim 2, in which an interference matrix (31) is formed by an integration operation over the entire overlap area (64) of all results obtained for each pixel of the overlap area (64), the calculation module (11) determining the global interference ratio Tbi/j of each serving interfered cell (62) by interfering cells (61).

8. Process according to claim 1, in which the Eb/N₀ ratio of the average power of the signal to the average spectral density of the noise is calculated at each pixel in the overlap area (64) by the calculation module (11) using the following formula:
Eb/N₀=Ec/I₀+spread gain,
where I₀ is the total value of the interference field, and where I₀=ΣI_{0 near}+thermal noise+I_{0 serving}, Ec is the value of the average power of the signal from the serving cell for the pixel, I_{0 serving} is the value of the interference field of the serving cell and the spread gain corresponds to the throughput value of the channel chosen as a parameter, the values for Ec and I_{0 serving} previously being determined by the calculation module (11) from attenuation data and the power fixed as a parameter for this cell.

9. Process according to claim 7 in which the comparison means enable the calculation module (11) to select at least three interfering cells (61) forming the cells introducing the greatest disturbance in comparison with values of the interfering matrix (31).

10. Process according to claim 8, in which a step for the display of the value of the Eb/N₀ ratio of the average power of the signal to the average spectral density of the noise is made for each pixel, for interfered cells (62) in the overlap area (64) using interactive interface means (3), the disturbance sub-areas (60) being identified by the use of a specific graphic representation for pixels of a serving interfered cell (62) for which the Eb/N₀ ratio is less than a threshold signal/interference ratio threshold defined as a parameter for the serving interfered cell (62).

11. Process according to claim 8, in which the calculation module (11) determines the Eb/N₀ or the Ec/I₀ ratio at each pixel in the overlap area (64), this ratio being compared at each pixel in the service area (63) with a threshold indicated as a parameter so as to calculate a value representative of the excess power of the interfering cell (61) for each interfering cell (61)
serving interfered cell (62) pair, this value being entered in a matrix.

12. Process according to claim 8, in which the calculation module (11) determines the Eb/N₀ or Ec/I₀ ratio at each pixel in the overlap area (64), this ratio being compared at each pixel in the service area (63) with a threshold indicated as a parameter so as to calculate a value representative of the disturbance within the interfered cell (61), for each interfered cell (61), the value of I₀ being equal to the sum of interference generated by interfering cells.

13. Process according to claim 9, in which the result of the calculated disturbance is used to make a check of the power for at least the most disturbing cell, by modification of the radiation diagram of an adaptive antenna of the cell, to increase the signal/interference ratio in this cell.

14. Computer system (1) for calculation and display of mutual interference in the down direction generated in a cellular radiotelephony network with a W-CDMA type access for implementation of the process according to claim 1, comprising memory means (2), a calculation module (11) and selection means (12), the said memory means (2) comprising data representative of geographic maps (CN), broken down into a plurality of points or pixels depending on the breakdown of the said network in a first memory (21), and data representative of a radio coverage related to the network in a second memory (22), the said system (1) being characterized in that it comprises:
interactive interface means (3) between the user and the said system (1), connected to the selection means (12) for selecting and displaying at least one working area (6) derived from map data (CN) and covered by a set of radio coverage cells arranged according to a layout defined by the data in the second memory (22),
configuration means (33, 34) selected by interactive means (3) to memorize a first sub-set of cells (61) to be considered as being interfering and a second sub-set of cells (62) to be considered as being interfered, in a configuration file (25) for the system (1) starting from any cells in the assembly covering the working area (6), the configuration means (33) enabling firstly the definition of threshold levels for signal/interference ratios and parameters related to the power of interfering cells (61), the traffic channel to be studied and the contour delimiting a calculation area in the working area (6), and also the memorization of these data in a configuration file (25), the calculation module (11) comprising means of determining the service area (63) served by the sub-set of the interfered cells (62), means of estimating the overlap of each interfering cell (61) with the service area (63) to define and memorize an overlap area (64) in a memory (23) in memorization means (2), and means of calculating the attenuation of the interfering cell (61), and attenuation of the serving interfered cell (62) for the pixel considered, for each point or pixel in the overlap area (64).

15. System according to claim 14, in which the calculation module (11) is connected to means (13) for extraction of data from the configuration file (25) and data representative of attenuations stored in a third memory (26) of the memorization means (2), the calculation module (11) determining a value representative of the signal/interference ratio at each pixel in the overlap area (64), starting from attenuations stored in the third memory (26) and parameters of the configuration file (25).

16. System according to claim 14 in which the interactive interface means (3) comprise means of displaying the value representative of the signal/interference ratio Eb/N₀, the average power of the signal to the average noise spectral density, and means of representing the disturbance represented by specific pixels for which the Eb/N₀ ratio is less than a threshold ratio of the signal/interference ratio input as a parameter for the serving interfered cell (62) for each serving interfered cell (61) of the sub-areas (60), and for each pixel in the overlap area (64).

17. System according to claim 14, characterized in that it comprises remote control means for controlling the power in at least one interfering cell (61) causing the greatest disturbance, by modification of the radiation diagram of an adaptive antenna of the said interfering cell (61).
